(19) United States
(12) Patent Application Publication
(10) Pub. No.: US 2021/0016610 A1
(43) Pub. Date: Jan. 21, 2021

(54) Sealant Material Composition and Pneumatic Tire

(71) Applicant: The Yokohama Rubber Co., LTD., Minato-ku, Tokyo (JP)

(72) Inventor: Kiyohito Takahashi, Hiratsuka-shi, Kanagawa (JP)

(21) Appl. No.: 16/982,571

(22) PCT Filed: Feb. 28, 2019
(86) PCT No.: PCT/JP2019/007817

§ 371 Date: Sep. 20, 2020

(30) Foreign Application Priority Data
Mar. 20, 2018 (JP) 2018-052548

(51) Int. Cl. B60C 19/12; B29C 73/16; C08L 23/22; C08L 23/28

(52) U.S. Cl. CPC B60C 19/122; B29C 73/163; C08L 2207/04; C08L 23/28; C08L 23/22

(57) ABSTRACT

A sealant material composition forming a sealant layer of a pneumatic tire provided with the sealant layer on a tire inner surface is prepared by blending from 1 part by mass to 40 parts by mass of a crosslinking aid and from 50 parts by mass to 400 parts by mass of a liquid isobutylene-isoprene copolymer having a molecular weight from 10000 to 60000 per 100 parts by mass of a halogenated butyl rubber.

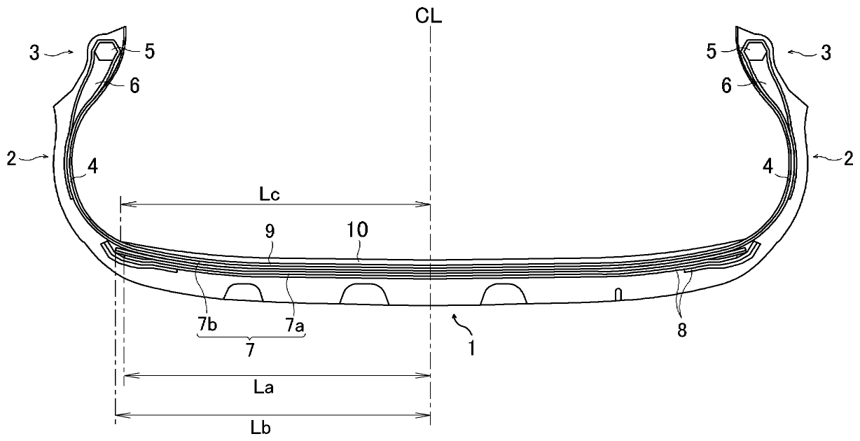

### TECHNICAL FIELD

The present technology relates to a sealant material composition that forms a sealant layer of a self-sealing type pneumatic tire provided with a sealant layer on a tire inner surface, and a pneumatic tire using the sealant material composition.

### BACKGROUND ART

In pneumatic tires, it has been proposed to provide a sealant layer on the inner side of the innerliner layer in the tire radial direction of the tread portion (for example, see Japan Unexamined Patent Publication No. 2006-152110). In such a pneumatic tire, when a foreign substance such as a nail or the like penetrates into the tread portion, the sealant flows into the through hole, which makes it possible to suppress reduction in air pressure and to maintain travel.

In the self-sealing type pneumatic tire described above, when the viscosity of the sealant is lowered, the sealant may provide improved sealing properties because it easily flow into the through hole. However, the sealant inadvertently flows toward the tire center side due to the effects of heat and centrifugal force applied during traveling, and as a result, there is a risk that traveling performance such as steering stability and the like may be negatively affected. On the other hand, when the viscosity of the sealant is increased in order to prevent flow of the sealant, sealing properties may deteriorate. Thus, it is difficult to ensure good sealing properties while suppressing flow of the sealant due to traveling, and there is a demand for a measure for providing these performances in a well-balanced, compatible manner by improving the physical properties of the sealant material composition that forms the sealant layer.

### SUMMARY

The present technology provides a sealant material composition that makes it possible to ensure good sealing properties and to suppress flow of sealant due to traveling, and a pneumatic tire.

A sealant material composition according to an embodiment of the present technology is a sealant material composition forming a sealant layer of a pneumatic tire provided with the sealant layer on a tire inner surface, the sealant material composition being prepared by blending from 1 part by mass to 40 parts by mass of a crosslinking aid and from 50 parts by mass to 400 parts by mass of a liquid isobutylene-isoprene copolymer having a molecular weight from 10000 to 60000 per 100 parts by mass of a halogenated butyl rubber.

Because of the blending as described above, the sealant material composition according to an embodiment of the present technology can obtain suitable elasticity that does not flow during traveling while ensuring sufficient viscosity to obtain good sealing properties, and can provide these performances in a well-balanced, compatible manner. In particular, the crosslinking aid, the halogenated butyl rubber, and the liquid isobutylene-isoprene copolymer are crosslinked in the sealant material composition, so that a net-like structure is formed, whereby flow during traveling can be effectively suppressed while good sealing properties are maintained. Furthermore, the use of the halogenated butyl rubber increases reactivity between the rubber component and sulfur or the organic peroxide, and thus the processability of the sealant material composition can be improved. Furthermore, in a case in which the halogenated butyl rubber is contained in the rubber composition forming the innerliner layer of the pneumatic tire, this halogenated butyl rubber, the halogenated butyl rubber contained in the sealant material composition, and the crosslinking aid are subjected to quinoid crosslinking to be bonded among these three, so that more excellent adhesion can be ensured.

In the sealant material composition according to an embodiment of the present technology, the crosslinking aid is preferably quinone dioxime. By using quinone dioxime in this manner, adhesion can be further improved.

In the sealant material composition according to an embodiment of the present technology, a ratio A/B of a blending amount A of the crosslinking aid to a blending amount B of the liquid isobutylene-isoprene copolymer is preferably from 1/10 to 10/1. By defining the blending ratio of the crosslinking aid to the liquid isobutylene-isoprene copolymer as described above, the physical properties of the sealant material composition are improved, which is advantageous for providing ensuring of sealing properties and suppression of sealant flow in a well-balanced, compatible manner.

In the sealant material composition according to an embodiment of the present technology, an amount from 1 part by mass to 40 parts by mass of an organic peroxide is preferably blended per 100 parts by mass of the halogenated butyl rubber. By blending the organic peroxide as described above, oxime crosslinking is promoted and the physical properties of the sealant material composition are improved, which is advantageous for providing ensuring of sealing properties and suppression of sealant flow in a well-balanced, compatible manner.

The sealant material composition according to an embodiment of the present technology described above can be suitably used in a sealant layer of a pneumatic tire including a tread portion having an annular shape extending in a tire circumferential direction; a pair of sidewall portions disposed on both sides of the tread portion; and a pair of bead portions disposed on an inner side of the sidewall portions in a tire outer diameter direction, and having at least a sealant layer on an inner side of an innerliner layer in a tire radial direction of the tread portion, and at this time, the innerliner layer contains a halogenated butyl rubber. In this manner, the halogenated butyl rubber contained in the innerliner layer, the halogenated butyl rubber contained in the sealant material composition, and the crosslinking aid are subjected to quinoid crosslinking to be bonded among these three, so that more excellent adhesion can be ensured.

In the pneumatic tire according to an embodiment of the present technology, the sealant layer preferably has a thickness from 0.5 mm to 5.0 mm. By configuring the thickness of the sealant layer to be within a suitable range in this way, sealant flow can be suppressed while good sealing properties are ensured. Furthermore, processability at the time of attaching the sealant layer to the tire inner surface is also improved.

The pneumatic tire according to an embodiment of the present technology can have a specification in which the sealant layer is formed by attaching a sheet-like molded sealant material made of the sealant material composition according to an embodiment of the present technology described above entirely around a circumference of a tire inner surface. Alternatively, the pneumatic tire can have a specification in which the sealant layer is formed by spirally attaching a string-like or band-like molded sealant material made of the sealant material composition according to an embodiment of the present technology described above to a tire inner surface. In either case, the sealant layer can be efficiently and reliably provided in a desired region.

In the pneumatic tire according to an embodiment of the present technology, a center position of the sealant layer in a tire lateral direction is preferably arranged within a range of ±10 mm in the tire lateral direction from a tire equator. Thus, by providing the sealant layer, impact on the uniformity of the pneumatic tire can be prevented.

In the pneumatic tire according to an embodiment of the present technology, a plurality of belt layers are embedded in the tread portion, a layer having a smallest belt width of the plurality of belt layers is a minimum belt layer, a layer having a largest belt width of the plurality of belt layers is a maximum belt layer, a distance from the tire equator to an end portion of the minimum belt layer is La, a distance from the tire equator to an end portion of the maximum belt layer is Lb, and a distance from the tire equator to an end portion of the sealant layer in the tire lateral direction is Lc, and the distances La, Lb, Lc preferably satisfy the relationship La≤Lc≤1.05×Lb. Thus, flow at the end portion of the sealant layer can be effectively suppressed while sealing properties are ensured with the sealant layer covering the appropriate range.

### BRIEF DESCRIPTION OF THE DRAWING

The drawing is a meridian cross-sectional view illustrating a self-sealing type pneumatic tire according to an embodiment of the present technology.

### DETAILED DESCRIPTION

Configurations of embodiments of the present technology will be described in detail below with reference to the accompanying drawings.

A rubber component in a sealant material composition according to an embodiment of the present technology is a halogenated butyl rubber. The use of the halogenated butyl rubber increases reactivity between the rubber component and sulfur or the organic peroxide, and thus the processability of the sealant material composition can be improved. Any halogenated butyl rubber that is regularly used in sealant material compositions can be used. In particular, from the viewpoint of reactivity with sulfur and an organic peroxide and processability, a brominated butyl rubber or a chlorinated butyl rubber is preferably used.

The sealant material composition according to an embodiment of the present technology is always blended with a crosslinking aid and a liquid isobutylene-isoprene copolymer. By including these, the crosslinking aid, the halogenated butyl rubber, and the liquid isobutylene-isoprene copolymer are crosslinked in the sealant material composition, so that a net-like structure is formed, whereby flow during traveling can be effectively suppressed while good sealing properties are maintained.

Examples of the crosslinking aid include sulfenamide, thiazole, thiuram, thiourea, guanidine, dithiocarbamate, aldehyde-amine, aldehyde-ammonia, imidazoline, xanthogen, and quinone dioxime compounds (quinoid compounds). Among these, quinone dioxime compounds (quinoid compounds) can be suitably used. Examples of the quinone dioxime compounds include p-benzoquinone dioxime, p-quinone dioxime, p-quinone dioxime diacetate, p-quinone dioxime dicaproate, p-quinone dioxime dilaurate, p-quinone dioxime distearate, p-quinone dioxime dicrotonate, p-quinone dioxime dinaphthenate, p-quinone dioxime succinate, p-quinone dioxime adipate, p-quinone dioxime difuroate, p-quinone dioxime dibenzoate. The blending amount of the crosslinking aid is from 1 part by mass to 40 parts by mass, preferably from 10 parts by mass to 30 parts by mass, per 100 parts by mass of the halogenated butyl rubber. When the blending amount of the crosslinking aid is less than 1 part by mass, sufficient crosslinking will not be achieved, and the effect of forming the net-like structure described above will not be obtained. When the blending amount of the crosslinking aid exceeds 40 parts by mass, the crosslinking density will become excessively high, and the sealing properties will decline.

The liquid isobutylene-isoprene copolymer has a molecular weight from 10000 to 60000, and preferably from 20000 to 50000. When the molecular weight is less than 10000, the fluidity will be negatively affected. When the molecular weight exceeds 60000, the sealing properties will be negatively affected. The blending amount of the liquid isobutylene-isoprene copolymer is from 50 parts by mass to 400 parts by mass, preferably from 100 parts by mass to 300 parts by mass, per 100 parts by mass of the halogenated butyl rubber. When the blending amount of the liquid isobutylene-isoprene copolymer is less than 50 parts by mass, the sealing properties will be negatively affected. When the blending amount of the liquid isobutylene-isoprene copolymer exceeds 400 parts by mass, the fluidity cannot be suppressed.

When the crosslinking aid and the liquid isobutylene-isoprene copolymer are used in combination in this manner, the ratio A/B of the blending amount A of the crosslinking aid to the blending amount B of the liquid isobutylene-isoprene copolymer may preferably be set to from 1/10 to 10/1, and more preferably from 1/5 to 5/1. Such a blending ratio makes it possible to provide ensuring of sealing properties and prevention of sealant flow in a better-balanced, compatible manner.

An organic peroxide is preferably further blended to the sealant material composition according to an embodiment of the present technology, in addition to the crosslinking aid and the liquid isobutylene-isoprene copolymer described above. By blending the organic peroxide, crosslinking by the crosslinking aid (quinone dioxime compound) described above is promoted, which helps achieve good crosslinking for ensuring sealing properties and preventing sealant flow. The blending amount of the organic peroxide is preferably from 1 part by mass to 40 parts by mass, more preferably from 5 parts by mass to 20 parts by mass, per 100 parts by mass of the halogenated butyl rubber. When the blending amount of the organic peroxide is less than 1 part by mass, the content of the organic peroxide is substantially identical to that in which the organic peroxide is not included, whereby the crosslinking effect by the organic peroxide cannot be achieved. When the blending amount of the organic peroxide exceeds 40 parts by mass, crosslinking of the sealant material composition will proceed too far, and the sealing properties will decline.

Examples of the organic peroxide include dicumyl peroxide, t-butyl cumyl peroxide, benzoyl peroxide, dibenzoyl peroxide, butyl hydroperoxide, p-chlorobenzoyl peroxide, 1,1,3,3-tetramethylbutyl hydroperoxide, and the like. In particular, organic peroxides having a 1-minute half-life temperature of from 100° C. to 200° C. are preferable, and among the aforementioned specific examples, dicumyl peroxide and t-butyl cumyl peroxide are particularly preferable. Note that in the present technology, “1-minute half-life temperature” generally refers to the value described in the “Organic Peroxide Catalog No. 10 Ed.” from NOF Corp., and, if not stated, the value determined from thermal decomposition in an organic solvent in the identical manner as described in the catalog is employed.

Because of the blending as described above, the sealant material composition according to an embodiment of the present technology can obtain suitable elasticity that does not flow during traveling while ensuring sufficient viscosity to obtain good sealing properties, and can provide these performances in a well-balanced, compatible manner. In particular, the crosslinking aid, the halogenated butyl rubber, and the liquid isobutylene-isoprene copolymer are crosslinked in the sealant material composition, so that a net-like structure is formed, whereby flow during traveling can be effectively suppressed while good sealing properties are maintained. Furthermore, the use of the halogenated butyl rubber increases reactivity between the rubber component and sulfur or the organic peroxide, and thus the processability of the sealant material composition can be improved. Thus, when the sealant material composition is adopted in the sealant layer of the self-sealing type pneumatic tire described below, excellent sealing properties can be exhibited without causing flow of the sealant layer in traveling conditions.

As illustrated in the drawing, the pneumatic tire according to an embodiment of the present technology includes a tread portion 1 having an annular shape extending in the tire circumferential direction, a pair of sidewall portions 2 disposed on both sides of the tread portion 1, and a pair of bead portions 3 disposed on an inner side of the sidewall portions 2 in the tire radial direction. Note that “CL” in the drawing denotes a tire equator. Additionally, the drawing is a meridian cross-sectional view, and accordingly, although not illustrated, each of the tread portion 1, the sidewall portion 2, and the bead portions 3 extends in the tire circumferential direction to form an annular shape. Thus, the basic structure of the toroidal shape of the pneumatic tire is configured. Other tire components in the meridian cross-sectional view are also formed in an annular shape extending in the tire circumferential direction unless otherwise indicated.

In the example of the drawing, a carcass layer 4 is mounted between the left-right pair of bead portions 3. The carcass layer 4 includes a plurality of reinforcing cords extending in the tire radial direction, and is folded back around a bead core 5 and a bead filler 6 disposed in each of the bead portions 3 from a vehicle inner side to a vehicle outer side. Additionally, the bead fillers 6 are disposed on the outer circumferential side of the bead cores 5, and each bead filler 6 is enveloped by a main body portion and a folded back portion of the carcass layer 4.

On the other hand, in the tread portion 1, a plurality of belt layers 7 (two layers in the drawing) are embedded on an outer circumferential side of the carcass layer 4. Of the plurality of belt layers 7, a layer having the smallest belt width is referred to as a minimum belt layer 7a, and a layer having the largest belt width is referred to as a maximum belt layer 7b. The belt layers 7 each include a plurality of reinforcing cords that are inclined with respect to the tire circumferential direction, with the reinforcing cords of the different layers arranged in a criss-cross manner. In these belt layers 7, the inclination angle of the reinforcing cords with respect to the tire circumferential direction ranges from, for example, 10° to 40°. In addition, a belt reinforcing layer 8 is provided on the outer circumferential side of the belt layers 7 in the tread portion 1. In the illustrated example, the belt cover layer 8 has two layers provided: a full cover layer covering the entire width of the belt layers 7 and an edge cover layer disposed on the outer circumferential side of the full cover layer to cover only the end portions of the belt layers 7. The belt reinforcing layer 8 includes an organic fiber cord oriented in the tire circumferential direction, and an angle of the organic fiber cord with respect to the tire circumferential direction is set to, for example, from 0° to 5°.

Additionally, on a tire inner surface, an innerliner layer 9 is disposed along the carcass layer 4. This innerliner layer 9 is a layer for preventing air filled in the tire from passing out of the tire. The innerliner layer 9 is formed from a rubber composition based on butyl rubber having an air permeation preventing performance, for example. Alternatively, it may be formed of a resin layer having a thermoplastic resin as a matrix. In the case of the resin layer, an elastomer component may be dispersed in the matrix of the thermoplastic resin. Preferably, in order to improve adhesion to the sealant material composition according to an embodiment of the present technology described above, the innerliner layer 9 preferably contains a halogenated butyl rubber. The halogenated butyl rubber may preferably contain from 50 parts by mass to 100 parts by mass, and more preferably from 80 parts by mass to 100 parts by mass, in 100 parts by mass of the rubber component forming the innerliner layer 9. When the halogenated butyl rubber is contained, the halogenated butyl rubber, the halogenated butyl rubber contained in the sealant material composition, and the crosslinking aid are subjected to quinoid crosslinking to be bonded among these three, so that more excellent adhesion can be ensured.

As illustrated in the drawing, a sealant layer 10 is provided on the inner side of the innerliner layer 9 in the tire radial direction of the tread portion 1. The sealant material composition according to an embodiment of the present technology is used in the sealant layer 10. The sealant layer 10 is attached to the inner surface of a pneumatic tire having the basic structure described above, and for example, when foreign material such as a nail or the like penetrates into the tread portion 1, the sealant material that forms the sealant layer 10 flows into the through hole, which makes it possible to suppress reduction in air pressure and to maintain travel.

The sealant layer 10 has a thickness of from 0.5 mm to 5.0 mm, for example. By having this degree of thickness, sealant flow can be suppressed in traveling conditions while good sealing properties are ensured. Furthermore, processability at the time of attaching the sealant layer 10 to the tire inner surface is also improved. When the thickness of the sealant layer 10 is less than 0.5 mm, it becomes difficult to ensure sufficient sealing properties. When the thickness of the sealant layer 10 exceeds 5.0 mm, the tire weight increases to degrade rolling resistance. Note that the sealant layer 10 has an average thickness.

The sealant layer 10 can be formed by being attached to the inner surface of the vulcanized pneumatic tire later. For example, the sealant layer 10 can be formed by attaching a sheet-like molded sealant material made of a sealant material composition described below entirely around the circumference of a tire inner surface, or by spirally attaching a string-like or band-like molded sealant material made of a sealant material composition described below to the tire inner surface. In addition, by heating the sealant material composition at this time, variations in the performance of the sealant material composition can be suppressed. The heating conditions are preferably at a temperature from 140° C. to 180° C., more preferably from 160° C. to 180° C., and for a heating time of preferably from 5 minutes to 30 minutes, more preferably from 10 minutes to 20 minutes. According to the method for manufacturing a pneumatic tire, a pneumatic tire having excellent sealing properties when punctured and that is not prone to cause sealant flow can be efficiently manufactured.

The sealant layer 10 is preferably provided at a substantially center position in the tire lateral direction in consideration of the impact on the uniformity of the pneumatic tire. In other words, the center position of the sealant layer 10 in the tire lateral direction is preferably disposed in a range of ±10 mm in the tire lateral direction from a tire equator CL. When the center position of the sealant layer 10 in the tire lateral direction deviates from this range, the sealant layer 10 is provided offset in the tire lateral direction, which reduces the uniformity of the pneumatic tire.

Furthermore, the end portion of the sealant layer 10 in the tire lateral direction is preferably disposed near the end portion of the belt layer 7. Specifically, when the distance from the tire equator CL to the end portion of the minimum belt layer 7a is La, the distance from the tire equator CL to the end portion of the maximum belt layer 7b is Lb, and the distance from the tire equator CL to the end portion of the sealant layer 10 in the tire lateral direction is Lc, the distances La, Lb, Lc preferably satisfy the relationship La≤Lc≤1.05×Lb. Thus, flow at the end portion of the sealant layer 10 can be effectively suppressed while sealing properties are ensured with the sealant layer 10 covering the appropriate range. When the relationship between these distances is Lc<La, the region where the sealant layer 10 does not exist increases, making it difficult to ensure sufficient sealing properties near the end portion of the belt layer 7. When the relationship between these distances is Lc>1.05×Lb, the sealant layer 10 reaches near the sidewall portion 2 which is greatly deformed during traveling, and the flow in the tire equator CL direction of the sealant layer 10 is more likely to be induced due to the effects of softening caused by heat generated during traveling and centrifugal force.

The present technology is further explained below by examples. However, the scope of the present technology is not limited to these examples.

### Examples

Tires according to Comparative Examples 1 to 10 and according to Examples 1 to 14 were manufactured to be pneumatic tires having a tire size of 215/60R16, having a basic structure illustrated in the drawing, and including a sealant layer formed on an inner side of an innerliner layer in a tire radial direction of a tread portion, the tires being adjusted for composition of the sealant material composition that forms the sealant layer, whether the innerliner layer contains a halogenated butyl rubber, the thickness of the sealant layer, the distance from the tire equator at the center position of the sealant layer, and the end portion position of the sealant layer as indicated in Tables 1 to 3.

Note that in all the examples in Tables 1 to 3, the innerliner layer was made of a halogenated butyl rubber.

Adhesion, sealing properties, sealant fluidity, and low rolling performance for these test tires were evaluated according to the following test methods, and the results were indicated in Tables 1 to 3.

### Adhesion

The test tires were assembled on wheels having a rim size of 16×6.5 j, mounted on a drum testing machine, and subjected to high deflection test with an air pressure of 160 kPa, a load of 8.5 kN, and a traveling speed of 80 km/h for 80 hours, and then the adhesion state of the sealant was examined. When the region from the tire equator position to the outer end position of the sealant layer in the tire width direction was divided into quarters, the evaluation results were indicated by “excellent” in a case where no sealant peeling was observed, by “good” in a case where sealant peeling occurred in a region less than a quarter of the total region, and by “fail” in a case where sealant peeling occurred in a region at least a quarter of the total region.

### Sealing Properties

The test tires were assembled on wheels having a rim size of 16×6.5 j, mounted on a test vehicle, with an initial air pressure of 250 kPa, a load of 8.5 kN and a traveling speed of 80 km/h and traveled for 1 hour with a 4 mm-diameter nail driven into the tread portion, and then the air pressure was measured. The evaluation results were indicated by “excellent” in a case where the air pressure after traveling was at least 230 kPa and at most 250 kPa; by “good” in a case where the air pressure after traveling was at least 200 kPa and less than 230 kPa; and by “fail” in a case where the air pressure after traveling was less than 200 kPa.

### Sealant Fluidity

The test tires were assembled on wheels having a rim size of 16×6.5 j, mounted on a drum testing machine, and subjected to high deflection test with an air pressure of 160 kPa, a load of 8.5 kN, and a traveling speed of 80 km/h for 80 hours, and then the flow state of the sealant was examined. When the region from the tire equator position to the outer end position of the sealant layer in the tire lateral direction was divided into quarters, the evaluation results were indicated by “excellent” in a case where no sealant flow was observed, by “good” in a case where sealant flow occurred in a region less than a quarter of the total region, and by “fail” in a case where sealant flow occurred in a region at least a quarter of the total region.

### Low Rolling Performance

Each test tire was mounted on a wheel having a rim size of 16×6.5 J, with an air pressure of 160 kPa, using an indoor drum testing machine (drum diameter: 1707 mm), and traveled at a speed of 80 km/h while pushed against the drum under a load equivalent to 85% of the maximum load at the air pressure described in the 2009 JATMA (The Japan Automobile Tyre Manufacturers Association, Inc.) Year Book. At this time, the rolling resistance was measured. The evaluation results are expressed as index values using the reciprocal of the measurement values, with the Standard Example 1 being assigned the index of 100. A larger index value indicates lower rolling resistance and excellent low rolling performance.

TABLE 1

| | | | Comparative | | |
|---|---|---|---|---|---|
| | | | Example 1 | Example 1 | Example 2 |
| Sealant | Halogenated butyl rubber | Parts by mass | 100 | 100 | 100 |
| material | Non-halogenated butyl rubber | Parts by mass | | | |
| composition | Crosslinking aid 1 | Parts by mass | | 1 | 20 |
| | Crosslinking aid 2 | Parts by mass | | | |
| | Sulfur | Parts by mass | 40 | | |
| | Liquid polymer 1 | Parts by mass | 200 | 50 | 50 |
| | Liquid polymer 2 | Parts by mass | | | |
| | Liquid polymer 3 | Parts by mass | | | |
| | Liquid polymer 4 | Parts by mass | | | |
| | Organic peroxide | Parts by mass | 20 | 20 | 20 |
| | Ratio A/B | | 1/10 | 1/50 | 2/5 |
| Tire | Thickness of sealant layer | mm | 2.5 | 2.5 | 2.5 |
| | Center position of sealant layer | mm | 0 | 0 | 0 |

| Adhesion | | Good | Excellent | Excellent |
|---|---|---|---|---|
| Sealing properties | | Excellent | Good | Good |
| Sealant fluidity | | Good | Excellent | Excellent |
| Low rolling performance | Index value | 100 | 100 | 100 |

| | | | Example 3 | Example 4 | Example 5 |
|---|---|---|---|---|---|
| Sealant | Halogenated butyl rubber | Parts by mass | 100 | 100 | 100 |
| material | Non-halogenated butyl rubber | Parts by mass | | | |
| composition | Crosslinking aid 1 | Parts by mass | 40 | 20 | 40 |
| | Crosslinking aid 2 | Parts by mass | | | |
| | Sulfur | Parts by mass | | | |
| | Liquid polymer 1 | Parts by mass | 50 | 100 | 100 |
| | Liquid polymer 2 | Parts by mass | | | |
| | Liquid polymer 3 | Parts by mass | | | |
| | Liquid polymer 4 | Parts by mass | | | |
| | Organic peroxide | Parts by mass | 20 | 20 | 20 |
| | Ratio A/B | | 4/5 | 1/5 | 2/5 |
| Tire | Thickness of sealant layer | mm | 2.5 | 2.5 | 2.5 |
| | Center position of sealant layer | mm | 0 | 0 | 0 |

| Adhesion | | Excellent | Excellent | Excellent |
|---|---|---|---|---|
| Sealing properties | | Good | Good | Good |
| Sealant fluidity | | Excellent | Excellent | Excellent |
| Low rolling performance | Index value | 100 | 100 | 100 |

| | | | Comparative | | Comparative |
|---|---|---|---|---|---|
| | | | Example 2 | Example 6 | Example 3 |
| Sealant | Halogenated butyl rubber | Parts by mass | 100 | 100 | |
| material | Non-halogenated butyl rubber | Parts by mass | | | 100 |
| composition | Crosslinking aid 1 | Parts by mass | 0.1 | 20 | 20 |
| | Crosslinking aid 2 | Parts by mass | | | |
| | Sulfur | Parts by mass | | | |
| | Liquid polymer 1 | Parts by mass | 200 | 200 | 200 |
| | Liquid polymer 2 | Parts by mass | | | |
| | Liquid polymer 3 | Parts by mass | | | |
| | Liquid polymer 4 | Parts by mass | | | |
| | Organic peroxide | Parts by mass | 20 | 20 | 20 |
| | Ratio A/B | | 1/2000 | 1/10 | 1/10 |
| Tire | Thickness of sealant layer | mm | 2.5 | 2.5 | 2.5 |
| | Center position of sealant layer | mm | 0 | 0 | 0 |

| Adhesion | | Fail | Excellent | Fail |
|---|---|---|---|---|
| Sealing properties | | Excellent | Excellent | Excellent |
| Sealant fluidity | | Fail | Excellent | Excellent |
| Low rolling performance | Index value | 100 | 100 | 100 |

TABLE 2

| | | | | Comparative | | |
|---|---|---|---|---|---|---|
| | | | Example 7 | Example 4 | Example 8 | Example 9 |
| Sealant | Halogenated butyl rubber | Parts by mass | 100 | 100 | 100 | 100 |
| material | Non-halogenated butyl rubber | Parts by mass | | | | |
| composition | Crosslinking aid 1 | Parts by mass | 40 | 50 | 20 | 40 |
| | Crosslinking aid 2 | Parts by mass | | | | |
| | Sulfer | Parts by mass | | | | |
| | Liquid polymer 1 | Parts by mass | 200 | 200 | 400 | 400 |
| | Liquid polymer 2 | Parts by mass | | | | |
| | Liquid polymer 3 | Parts by mass | | | | |
| | Liquid polymer 4 | Parts by mass | | | | |
| | Organic peroxide | Parts by mass | 20 | 20 | 20 | 20 |
| | Ratio A/B | | 1/5 | 1/4 | 1/2 | 1/10 |
| Tire | Thickness of sealant layer | mm | 2.5 | 2.5 | 2.5 | 2.5 |
| | Center position of sealant layer | mm | 0 | 0 | 0 | 0 |
| Adhesion | | | Excellent | Excellent | Excellent | Excellent |
| Sealing properties | | | Good | Fail | Excellent | Excellent |
| Sealant fluidity | | | Excellent | Excellent | Excellent | Good |
| Low rolling performance | | Index value | 100 | 100 | 100 | 100 |

| | | | | Comparative | Comparative | Comparative |
|---|---|---|---|---|---|---|
| | | | Example 10 | Example 5 | Example 6 | Example 7 |
| Sealant | Halogenated butyl rubber | Parts by mass | 100 | 100 | 100 | 100 |
| material | Non-halogenated butyl rubber | Parts by mass | | | | |
| composition | Crosslinking aid 1 | Parts by mass | | 20 | 20 | 20 |
| | Crosslinking aid 2 | Parts by mass | 40 | | | |
| | Sulfur | Parts by mass | | | | |
| | Liquid polymer 1 | Parts by mass | 400 | | | |
| | Liquid polymer 2 | Parts by mass | | 200 | | |
| | Liquid polymer 3 | Parts by mass | | | 200 | |
| | Liquid polymer 4 | Parts by mass | | | | 200 |
| | Organic peroxide | Parts by mass | 20 | 20 | 20 | 20 |
| | Ratio A/B | | 1/10 | 1/10 | 1/10 | 1/10 |
| Tire | Thickness of sealant layer | mm | 2.5 | 2.5 | 2.5 | 2.5 |
| | Center position of sealant layer | mm | 0 | 0 | 0 | 0 |

| Adhesion | | Excellent | Fail | Fail | Fail |
|---|---|---|---|---|---|
| Sealing properties | | Good | Good | Fail | Fail |
| Sealant fluidity | | Good | Fail | Excellent | Fail |
| Low rolling performance | Index value | 100 | 100 | 100 | 100 |

TABLE 3

| | | | Comparative | Comparative | Comparative |
|---|---|---|---|---|---|
| | | | Example 8 | Example 9 | Example 10 |
| Sealant | Halogenated butyl rubber | Parts by mass | 100 | 100 | 100 |
| material | Non-halogenated butyl rubber | Parts by mass | | | |
| composition | Crosslinking aid 1 | Parts by mass | 20 | 20 | 20 |
| | Crosslinking aid 2 | Parts by mass | | | |
| | Sulfur | Parts by mass | | | |
| | Liquid polymer 1 | Parts by mass | | 10 | 500 |
| | Liquid polymer 2 | Parts by mass | | | |
| | Liquid polymer 3 | Parts by mass | | | |
| | Liquid polymer 4 | Parts by mass | | | |
| | Organic peroxide | Parts by mass | 20 | 20 | 20 |
| | Ratio A/B | | 1/10 | 2/1 | 1/25 |
| Tire | Thickness of sealant layer | mm | 2.5 | 2.5 | 2.5 |
| | Center position of sealant layer | mm | 0 | 0 | 0 |

| Adhesion | | Excellent | Excellent | Excellent |
|---|---|---|---|---|
| Sealing properties | | Fail | Fail | Excellent |
| Sealant fluidity | | Fail | Excellent | Fail |
| Low rolling performance | Index value | 100 | 100 | 100 |

| | | | Example 11 | Example 12 | Example 13 | Example 14 |
|---|---|---|---|---|---|---|
| Sealant | Halogenated butyl rubber | Parts by mass | 100 | 100 | 100 | 100 |
| material | Non-halogenated butyl rubber | Parts by mass | | | | |
| composition | Crosslinking aid 1 | Parts by mass | 20 | 20 | 20 | 20 |
| | Crosslinking aid 2 | Parts by mass | | | | |
| | Sulfur | Parts by mass | | | | |
| | Liquid polymer 1 | Parts by mass | 200 | 200 | 200 | 200 |
| | Liquid polymer 2 | Parts by mass | | | | |
| | Liquid polymer 3 | Parts by mass | | | | |
| | Liquid polymer 4 | Parts by mass | | | | |
| | Organic peroxide | Parts by mass | 20 | 20 | 20 | 20 |
| | Ratio A/B | | 1/10 | 1/10 | 1/10 | 1/10 |
| Tire | Thickness of sealant layer | mm | 0.5 | 5 | 2.5 | 2.5 |
| | Center position of sealant layer | mm | 0 | 0 | 5 | 10 |

| Adhesion | | Excellent | Excellent | Excellent | Excellent |
|---|---|---|---|---|---|
| Sealing properties | | Excellent | Excellent | Excellent | Excellent |
| Sealant fluidity | | Excellent | Excellent | Excellent | Excellent |
| Low rolling performance | Index value | 100 | 100 | 100 | 100 |

Types of raw materials used as indicated in Tables 1 to 3 are described below.
Halogenated butyl rubber: BROMOBUTYL 2222, available from JSR
Non-halogenated butyl rubber: Butyl rubber: BUTYL 268, available from JSR
Crosslinking aid 1: Quinone dioxime, VALNOC DM, available from Ouchi Shinko Chemical Industrial Co., Ltd.
Crosslinking aid 2: m-phenylene dimaleimide, VALNOC PM, available from Ouchi Shinko Chemical Industrial Co., Ltd.
Crosslinking agent 1: Sulfur: Small lumps of sulfur, available from Hosoi Chemical Industry Co., Ltd.
Liquid polymer 1: Liquid isobutylene-isoprene copolymer, Kalene (registered trademark) 80 (molecular weight: 36000), available from Royal Elastomers
Liquid polymer 2: Liquid polybutene, polybutene HV-15 (molecular weight: 630), available from JXTG Energy
Liquid polymer 3: Liquid isoprene rubber, LIR30 (molecular weight: 28000) available from Kuraray Co., Ltd.
Liquid polymer 4: Liquid polyisobutylene, Tetrax 3T (molecular weight: 30000), available from JXTG Energy
Organic peroxide 1: Dicumyl peroxide, Percumyl D 40, available from NOF Corp. (1-minute half-life temperature: 179° C.)

As is clear from Tables 1 to 3, the pneumatic tires of Examples 1 to 14 had improved adhesion of the sealant to the tire inner surface (innerliner layer) compared with the pneumatic tire of Comparative Example 1, and exhibited sealing properties, sealant fluidity, and low rolling performance of the tires that are equivalent or superior to those in Comparative Example 1.

In Comparative Example 2, adhesion and fluidity were negatively affected because the blending amount of the crosslinking aid in the sealant material composition was low. In Comparative Example 3, adhesion was negatively affected because the rubber component in the sealant material composition was a non-halogenated butyl rubber. In Comparative Example 4, sealing properties were negatively affected because the blending amount of the crosslinking aid in the sealant material composition was too high. In Comparative Example 5, adhesion and fluidity were negatively affected because the liquid polymer in the sealant material composition was not a liquid isobutylene-isoprene copolymer. In Comparative Example 6, adhesion and sealing properties were negatively affected because the liquid polymer in the sealant material composition was not a liquid isobutylene-isoprene copolymer. In Comparative Example 7, adhesion, sealing properties, and fluidity were negatively affected because the liquid polymer in the sealant material composition was not a liquid isobutylene-isoprene copolymer. In Comparative Example 8, sealing properties and fluidity were negatively affected because the sealant material composition contained no liquid polymer. In Comparative Example 9, sealing properties were negatively affected because the blending amount of the liquid isobutylene-isoprene copolymer in the sealant material composition was low. In Comparative Example 10, fluidity was negatively affected because the blending amount of the liquid isobutylene-isoprene copolymer in the sealant material composition was too high.

1. A sealant material composition forming a sealant layer of a pneumatic tire provided with the sealant layer on a tire inner surface, the sealant material composition being prepared by blending from 1 part by mass to 40 parts by mass of a crosslinking aid and from 50 parts by mass to 400 parts by mass of a liquid isobutylene-isoprene copolymer having a molecular weight from 10000 to 60000 per 100 parts by mass of a halogenated butyl rubber.

2. The sealant material composition according to claim 1, wherein the crosslinking aid is a quinone dioxime compound.

3. The sealant material composition according to claim 1, wherein a ratio A/B of a blending amount A of the crosslinking aid to a blending amount B of the liquid isobutylene-isoprene copolymer is from 1/10 to 10/1.

4. The sealant material composition according to claim 1, wherein an amount from 1 part by mass to 40 parts by mass of an organic peroxide is blended per 100 parts by mass of the halogenated butyl rubber.

5. A pneumatic tire comprising: a tread portion having an annular shape extending in a tire circumferential direction; a pair of sidewall portions disposed on both sides of the tread portion; and a pair of bead portions disposed on an inner side of the sidewall portions in a tire outer diameter direction, and having at least a sealant layer made of the sealant material composition according to claim 1 on an inner side of an innerliner layer in a tire radial direction of the tread portion, the innerliner layer comprising a halogenated butyl rubber.

6. The pneumatic tire according to claim 5, wherein the sealant layer has a thickness from 0.5 mm to 5.0 mm.

7. The pneumatic tire according to claim 5, wherein the sealant layer is formed by attaching a sheet-like molded sealant material made of the sealant material composition entirely around a circumference of a tire inner surface.

8. The pneumatic tire according to claim 5, wherein the sealant layer is formed by spirally attaching a string-like or band-like molded sealant material made of the sealant material composition to a tire inner surface.

9. The pneumatic tire according to claim 5, wherein a center position of the sealant layer in a tire lateral direction is arranged within a range of ±10 mm in the tire lateral direction from a tire equator.

10. The pneumatic tire according to claim 5, wherein a plurality of belt layers are embedded in the tread portion, a layer having a smallest belt width of the plurality of belt layers is a minimum belt layer, a layer having a largest belt width of the plurality of belt layers is a maximum belt layer, a distance from the tire equator to an end portion of the minimum belt layer is La, a distance from the tire equator to an end portion of the maximum belt layer is Lb, a distance from the tire equator to an end portion of the sealant layer in the tire lateral direction is Lc, and the distances La, Lb, Lc satisfy a relationship La≤Lc≤1.05×Lb.

11. The sealant material composition according to claim 2, wherein a ratio A/B of a blending amount A of the crosslinking aid to a blending amount B of the liquid isobutylene-isoprene copolymer is from 1/10 to 10/1.

12. The sealant material composition according to claim 11, wherein an amount from 1 part by mass to 40 parts by mass of an organic peroxide is blended per 100 parts by mass of the halogenated butyl rubber.

13. A pneumatic tire comprising: a tread portion having an annular shape extending in a tire circumferential direction; a pair of sidewall portions disposed on both sides of the tread portion; and a pair of bead portions disposed on an inner side of the sidewall portions in a tire outer diameter direction, and having at least a sealant layer made of the sealant material composition according to claim 12 on an inner side of an innerliner layer in a tire radial direction of the tread portion, the innerliner layer comprising a halogenated butyl rubber.

14. The pneumatic tire according to claim 13, wherein the sealant layer has a thickness from 0.5 mm to 5.0 mm.

15. The pneumatic tire according to claim 14, wherein the sealant layer is formed by attaching a sheet-like molded sealant material made of the sealant material composition entirely around a circumference of a tire inner surface.

16. The pneumatic tire according to claim 14, wherein the sealant layer is formed by spirally attaching a string-like or band-like molded sealant material made of the sealant material composition to a tire inner surface.

17. The pneumatic tire according to claim 16, wherein a center position of the sealant layer in a tire lateral direction is arranged within a range of ±10 mm in the tire lateral direction from a tire equator.

18. The pneumatic tire according to claim 17, wherein a plurality of belt layers are embedded in the tread portion, a layer having a smallest belt width of the plurality of belt layers is a minimum belt layer, a layer having a largest belt width of the plurality of belt layers is a maximum belt layer, a distance from the tire equator to an end portion of the minimum belt layer is La, a distance from the tire equator to an end portion of the maximum belt layer is Lb, a distance from the tire equator to an end portion of the sealant layer in the tire lateral direction is Lc, and the distances La, Lb, Lc satisfy a relationship La≤Lc≤1.05×Lb.
